(19) United States
(12) Patent Application Publication
(10) Pub. No.: US 2025/0319707 A1
(43) Pub. Date: Oct. 16, 2025

(54) Pivoting Cutter

(71) Applicant: ZEBRA TECHNOLOGIES CORPORATION, Lincolnshire, IL (US)

(72) Inventors: Daniel P. Lanigan, Elgin, IL (US); Timothy T. Anderson, Antioch, IL (US); Edward C. Thomas, Gurnee, IL (US); Mark B. Urban, Mundelein, IL (US)

(21) Appl. No.: 18/634,503

(22) Filed: Apr. 12, 2024

(51) Int. Cl. B41J 11/68; B26D 1/16

(52) U.S. Cl. CPC B41J 11/68; B26D 1/165

(57) ABSTRACT

Pivoting Cutters are disclosed herein. An example pivoting cutter includes a printing device, comprising a frame; a printing assembly including a printhead and a platen roller; and a cutting assembly including a cutting blade and a media scraper, the cutting assembly is disposed on a mounting apparatus which is mated to the frame by a hinge and has an engaged position and a disengaged position, in the engaged position, the cutting assembly is immediately proximate to the printing assembly, such that the media scraper is configured to guide a printed media off the platen roller and to the cutting blade, and in the disengaged position, the mounting apparatus is rotated about the hinge, and a distance between the cutting assembly and the printing assembly is increased.

### BACKGROUND

Linerless labels were developed to reduce the quantity of waste produced during label printing using conventional liner-based labels. Linerless labels are labels that are printed and used without conventional release layers or liners. Liners are typically used to support pressure sensitive adhesive labels as they move through a printer. Liners protect the adhesive surface of the label from environmental contaminants and reduce the incidence of printer binding or jamming.

One challenge of using linerless labels is that the exposed adhesive surface of the linerless label media can undesirably adhere or stick to components of the printer, thereby complicating the operation of the printer. For example, the adhesive surface of the linerless label media can adhere and can become wrapped around the platen roller of the printer, thereby jamming (and possibly damaging) the platen roller and/or other components of the printer. Adhesion of the linerless label media to the platen roller can result from normal use and/or can be exacerbated by certain operating conditions, such as extreme temperatures, high humidity, other environmental conditions, adhesive deposits, prolonged pauses in operation, and the like.

### SUMMARY

In an embodiment, disclosed herein is a printing device, including: a frame; a printing assembly including a printhead and a platen roller; and a cutting assembly including a cutting blade and a media scraper, the cutting assembly is disposed on a mounting apparatus which is mated to the frame by a hinge and has an engaged position and a disengaged position, in the engaged position, the cutting assembly is immediately proximate to the printing assembly, such that the media scraper is configured to guide a printed media off the platen roller and to the cutting blade, and in the disengaged position, the mounting apparatus is rotated about the hinge, and a distance between the cutting assembly and the printing assembly is increased, thus increasing a space defined between the platen roller and the media scraper.

In a variation of this embodiment, the distance between the cutting assembly and the printing assembly is increased in a direction that is substantially collinear with a direction of a process path of the printed media defined between the printing assembly and the cutting assembly.

In a variation of this embodiment, the cutting blade and media scraper of the cutting assembly are operatively coupled to an end of the mounting apparatus opposite the hinge.

In a variation of this embodiment, an axis of rotation of the platen roller and an axis of rotation of the hinge are parallel.

In a variation of this embodiment, an axis of rotation of the platen roller and an axis of rotation of the hinge are skewed and non-orthogonal.

In a variation of this embodiment, the printing device further includes a latch, configured to secure the mounting apparatus when in the engaged position.

In a variation of this embodiment, the latch is further configured to release the mounting apparatus to transition to the disengaged position.

In a variation of this embodiment, the printed media comprises an adhesive surface.

In a variation of this embodiment, the mounting apparatus comprises a sensor, such that the printing device is restricted from actuating the cutting blade when the cutting assembly is in the disengaged position.

In a variation of this embodiment, rotation of the mounting apparatus about the hinge is biased by one or more springs joining the mounting apparatus and the frame.

In a variation of this embodiment, a range of rotation of the mounting apparatus about the hinge is biased by one or more linked members joining the mounting apparatus and the frame.

In a variation of this embodiment, an upper bound of a range of rotation of the mounting apparatus about the hinge is between 10 degrees and 45 degrees.

In a variation of this embodiment, an upper bound of a range of rotation of the mounting apparatus about the hinge is between 10 degrees and 25 degrees.

In a variation of this embodiment, the hinge is selected from a group consisting of a gate hinge, a spring hinge, a knife hinge, a barrel hinge, a block hinge, and combinations thereof.

In another embodiment, disclosed herein is a cutting device, including: a hinge; an actuatable cutting blade; a media scraper disposed adjacent to the actuatable cutting blade; a first mounting apparatus disposed on a first side of the hinge, the actuatable cutting blade and the media scraper are disposed on the first mounting apparatus; and a second mounting apparatus disposed on a second side of the hinge, the second mounting apparatus configured to be coupled to a printer, the first mounting apparatus and the second mounting apparatus rotate relative to each other about the hinge between an engaged position in which the actuatable cutting blade is configured to be operable and a disengaged position in which the actuatable cutting blade is configured to be inoperable.

In a variation of this embodiment, the cutting device is configured to interface with a latching mechanism of the printing device, such that the cutting device is secured and is restricted from rotating about the hinge when in the engaged position.

In a variation of this embodiment, the cutting device further includes a sensor and control circuitry, configured such that the cutting device is restricted from actuating the actuatable cutting blade when in the disengaged position.

In a variation of this embodiment, rotation of the cutting device about the hinge is biased by one or more springs joining the cutting device and the printing device.

In a variation of this embodiment, rotation of the cutting device about the hinge is biased by one or more linked members joining the cutting device and the printing device.

In a variation of this embodiment, the upper bound of a range of rotation of the cutting device about the hinge is between 10 degrees and 45 degrees.

In a variation of this embodiment, the upper bound of a range of rotation of the cutting device about the hinge is between 10 degrees and 25 degrees.

In a variation of this embodiment, the hinge is selected from a group consisting of a gate hinge, a spring hinge, a knife hinge, a barrel hinge, a block hinge, and combinations thereof.

In yet another embodiment, disclosed herein is a method of loading media into a printing device, including: installing a media supply on a hanger; inserting a portion of media of the media supply proximately to a printhead assembly, in a direction substantially perpendicular to a media process path defined by the printing device; feeding the portion of the media though a platen roller assembly, in a direction substantially collinear with the media process path; feeding the portion of the media though a cutter assembly, in a direction substantially collinear to the media process path; transitioning the printhead assembly into an engaged position; transitioning the cutter assembly to an engaged position by rotating the cutting assembly about a hinge such that the cutting assembly is adjacent to the platen roller assembly.

In still yet another embodiment, disclosed herein is a method of removing a media jam from a printing device, including transitioning a cutter assembly of the printing device to a disengaged position by rotating the cutter assembly about a hinge, increasing a distance between a media scraper of the cutter assembly and a platen roller assembly, removing jammed media from the platen roller assembly.

In yet another embodiment, disclosed herein is method of forming a printer, including: installing a printhead assembly including a platen roller to a frame; installing a cutting device including an actuatable blade, a media scraper and mounting apparatus to the frame via a hinge, such that the actuatable blade and media scraper are operatively coupled to an end of the mounting apparatus opposite the hinge and rotating the cutting device about the hinge changes a distance between the media scraper and the platen roller in a direction substantially collinear with a media process path of the printer.

In yet another embodiment, disclosed herein is a printing device, including: a cutting assembly driven by a motor, the cutting assembly configured to be moved between an engaged position and a disengaged position; a sensor configured to detect whether the cutting assembly is in the engaged position or the disengaged position; and a processor configured to: disable the cutting assembly in response to an output of the sensor indicating the cutting assembly is in the disengaged position; and enable the cutting assembly in response to the output of the sensor indicating the cutting assembly is in the engaged position.

In a variation of this embodiment, the printing device further includes a second sensor configured to detect whether a faceplate of the cutting assembly is coupled to the cutting assembly, wherein the processor is configured to disable the cutting assembly in response to an output of the second sensor indicating the faceplate has been removed from the cutting assembly and enable the cutting assembly in response to the output of the sensor indicating the cutting assembly is in the engaged position.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a printing device according to embodiments of the present disclosure.

FIGS. 2A-2B illustrate components of the printing device, according to embodiments of the present disclosure.

FIGS. 3A-3B illustrate a cutting assembly of a printing device, according to embodiments of the present disclosure.

FIG. 4 illustrates a platen roller assembly and latch assembly of a printing device, according to embodiments of the present disclosure.

FIGS. 5A-5B illustrate configurations of a cutting assembly relative to a platen roller assembly, according to embodiments of the present disclosure.

FIG. 6 illustrates a block diagram of an example control circuit for a printing device, according to embodiments of the present disclosure.

FIG. 7 illustrates a flowchart of a method for loading media into a printing device, according to embodiments of the present disclosure.

FIG. 8 illustrates a flowchart of a method for removing a media jam from a printing device, according to embodiments of the present disclosure.

FIG. 9 illustrates a flowchart of a method of forming a printer, according to embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Embodiments of media processing devices, such as printers, of the present disclosure may process (e.g., print, encode, etc.) media by drawing the media from the media source and routing the media proximately to various processing components (e.g., printhead, RFID reader/encoder, magnetic stripe reader/encoder etc.). Processing the media from the media source may facilitate continuous or batch media processing. As an example, embodiments of media processing devices of the present disclosure may be configured to print and/or encode media drawn from a media source, such as roll, spool, or fanfold. Such media may include a continuous web such as a spool of media. The continuous web of media is coated on one surface with a pressure sensitive adhesive and includes a printable surface on the opposite surface. For thermal transfer printing, the printable surface of the media is configured to receive a pigment (e.g., ink, resin, wax-resin, etc.) that is transferred from a ribbon supply. For direct thermal printing, a thermal printhead of the printer directly contacts the printable surface triggering a chemical and/or physical change in a thermally sensitive dye covering and/or embedded in at least a portion of the printable surface of the media.

The web of media is routed along a feed path from the media supply to a print position located adjacent to the printhead (e.g., a thermal printhead). The continuous web of media is pulled through the feed path by a driven platen roller. For linerless media, the platen roller is designed to contact the adhesive surface of the linerless media as it pulls the linerless media through the feed path. The printhead is generally configured to form a nip with the platen roller to pinch the linerless media between the printhead and the platen roller. This pinching or compressive force provides adequate print quality, and in some applications, ensures that a sufficient tension is maintained along the continuous web of linerless media. Once printed, the printed portion of the linerless label media is advanced outwardly from the printer through a media outlet by the platen roller where it may be cut and/or torn to separate the printed label from the media supply.

As the media is fed past the platen roller, the adhesive of the linerless media may cause the linerless media to adhere to the platen roller as the platen roller assembly rotates. As a result, the media may adhere to and/or wrap around the platen roller and/or jam at the platen roller. Removal of the media wrap on the platen roller may be difficult because access to the platen roller in situ is limited due to operational and structure constraints of the media processing device (e.g., printer). For example, the components of the media processing device are typically positioned close together within an internal cavity of a housing having limited space. For instance, the media outlet or exit is generally too narrow for a user to access the platen roller through the media exit, and when a door assembly of the media processing device is in the open position, exposing an internal cavity, a printhead assembly and/or cutter assembly may be positioned in a manner that makes it difficult to reach the platen roller and remove the wrapped media from the platen roller. For example, in an engaged position, the printhead is positioned adjacent to platen roller typically leaving just enough space for the thickness of the media to pass through. In a disengaged position, the printhead may be moved away from the platen roller. However, the movement of the printhead assembly is also limited such that there is typically less than about one inch between the printhead and the platen roller. As another example, the cutting assembly may be positioned between the platen roller and the media exit and may further impede access to the platen roller. As another example, the non-driven or distal end of the platen roller is typically retained within a frame, and in some instances, only extends a small distance (e.g., less than one hundredth of an inch) such that manipulation of the distal end of the platen roller is typically not possible or practical.

In accordance with embodiments of the present disclosure, the media processing device, such as a printer includes a cutting assembly, the cutting assembly including a motor, an actuatable cutting blade, a media scraper, a mounting apparatus, and a hinge. The cutting assembly is configured to move between an engaged position and a disengaged position by rotating about an axis of rotation of the hinge. The actuatable cutting blade and media scraper are operably disposed at a first end of the mounting apparatus (e.g. a frame, bracket, chassis, or plate), opposite the hinge, disposed at the second end of the mounting apparatus. The hinge includes mating surfaces by which the hinge is secured on a first side to the mounting apparatus and on the second side secured to the frame (e.g. chassis, structural members, and/or baseplate) of the printer. In the engaged position, the scraper is immediately proximate (e.g. adjacent) to the platen roller, and the cutting assembly is secured to the printer at a second point of contact by a latching mechanism (e.g. latch, clip, magnet, and/or snap). When the latching mechanism is disengaged (e.g. selectively by a user), the cutting assembly is operable to rotate about the hinge, thus increasing the distance between the scraper and the platen roller, which may facilitate a user to access the platen roller (e.g., from a front and/or side of the printer) to remove a jam or blockage.

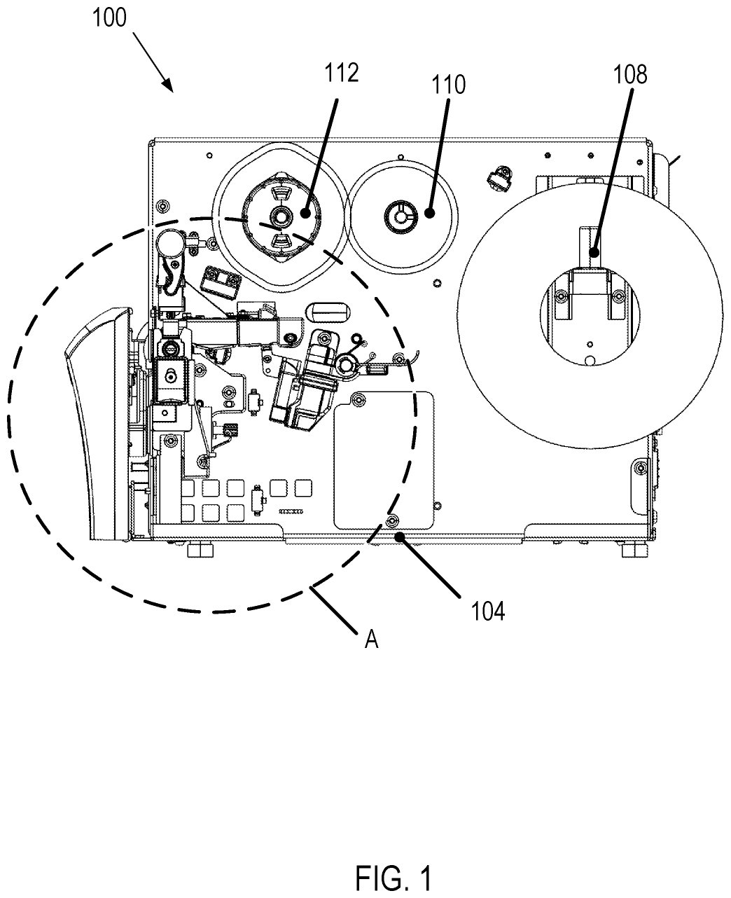

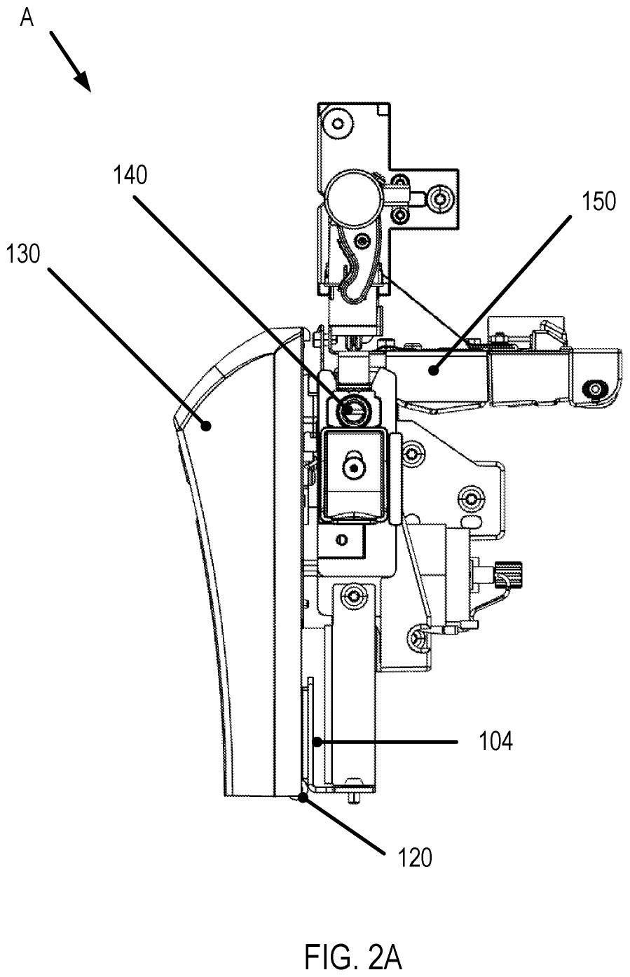

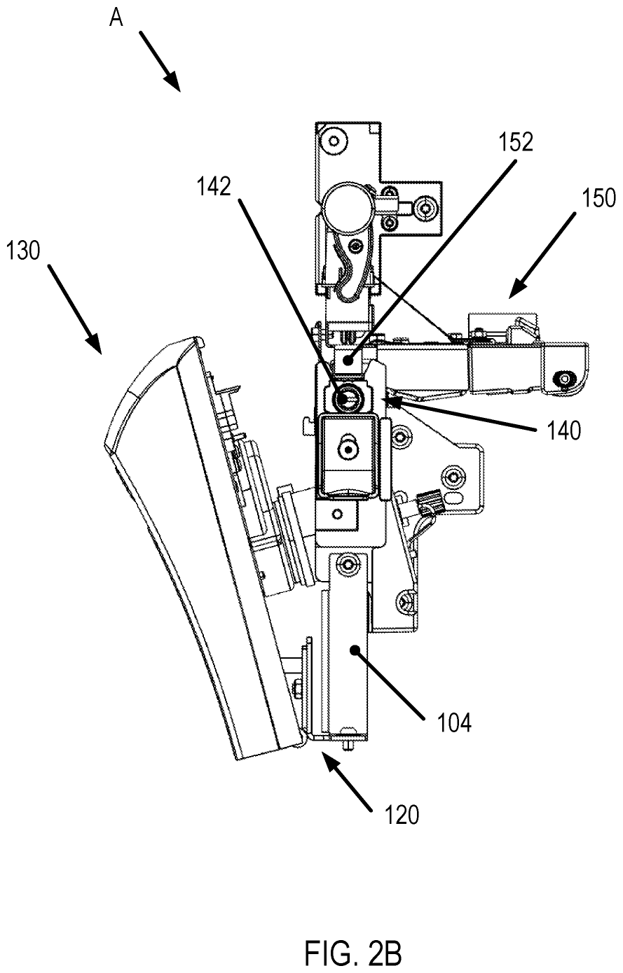

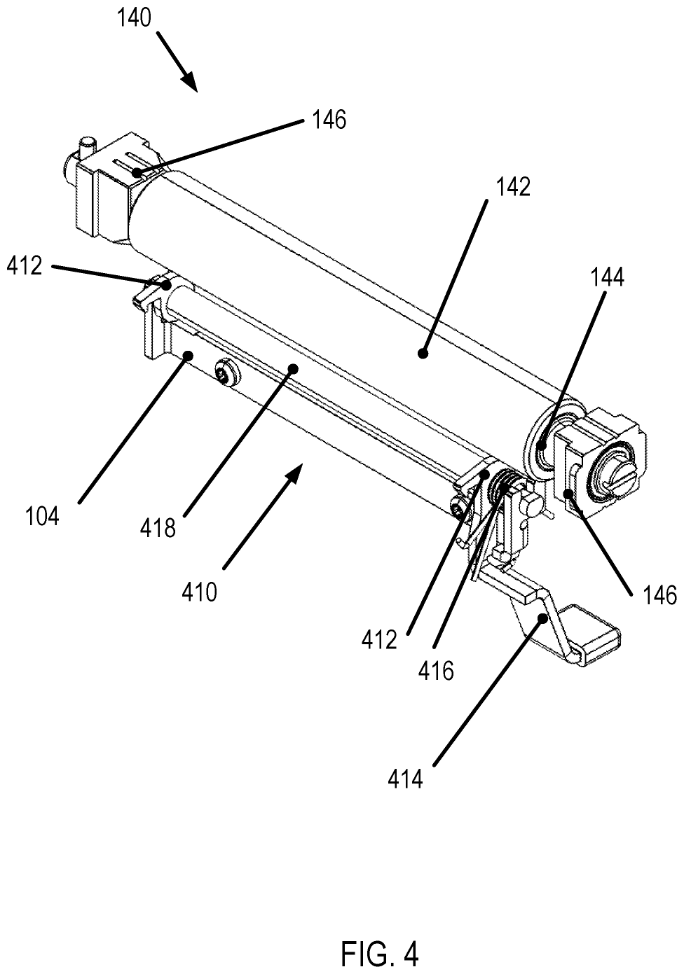

FIG. 1 illustrates a device 100 (e.g. printer, media processing device, printing device), according to embodiments of the present disclosure. The device 100 includes a housing (not illustrated) a frame 104 (e.g. (a) structural member(s), such as a base and/or chassis configured to support at least some of the internal components in the device 100, mounting apparatus). The frame 104 may generally refer to the various support and structural members disposed about that device 100, portions of which may be considered part of constituent assemblies within the device 100. The housing may include a front panel, a rear panel, a side panel, a support surface, an access door assembly and a user interface. The frame 104 supports a media hanger or spindle 108, a ribbon supply spindle 110 (e.g., in thermal transfer embodiments), a ribbon take-up spindle 112 (e.g., in thermal transfer embodiments), a cutting assembly 130 (Sec FIGS. 2A-B, 3A-B, 5A-B), a printhead assembly 150 including a printhead 152 (See FIG. 2), a platen assembly 140 including a platen roller 142 (See FIGS. 2, 4), as well as electronics and drive components behind the frame 104 (in the orientation illustrated in FIG. 1). The electronic and/or drive components may be operatively coupled to the media hanger or spindle 108, the ribbon supply spindle 110, the ribbon take-up spindle 112, the printhead 152 of the printhead assembly 150, and/or the platen roller 142 of the platen assembly 140 (See FIGS. 2, 4) to control the media hanger or spindle 108, the ribbon supply spindle 110, the ribbon take-up spindle 112, the printhead of the printhead assembly 150 (See FIG. 2), and/or the platen roller 142 of the platen assembly 140 (See FIGS. 2, 4) (e.g., to rotate the media hanger or spindle 108, the ribbon supply spindle 110, the ribbon take-up spindle 112, the printhead of the printhead assembly 150 (See FIG. 2), and/or the platen roller 142 of the platen assembly 140). FIG. 1 defines region A, shown in greater detail in FIGS. 2A-2B.

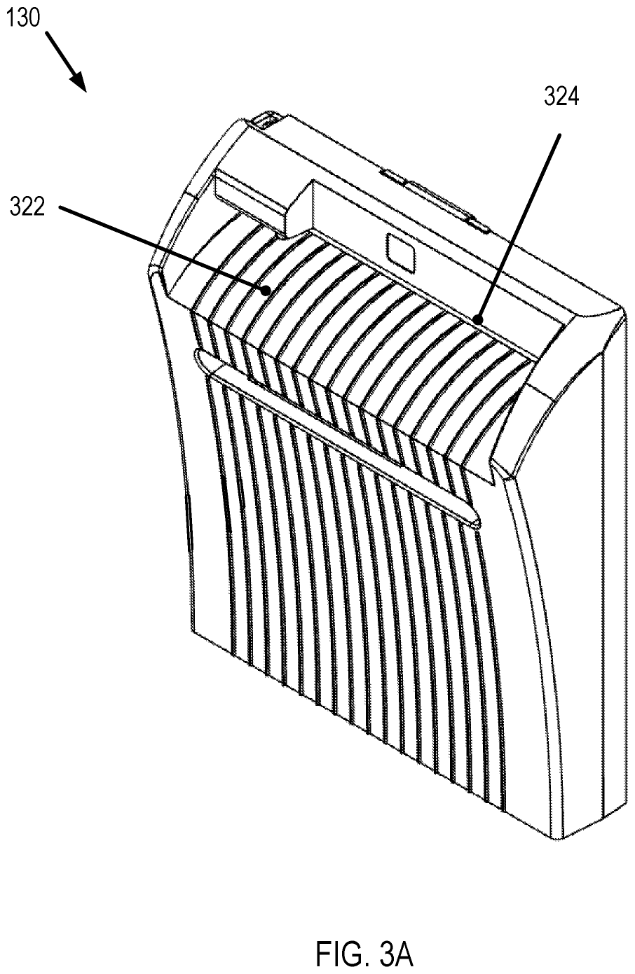

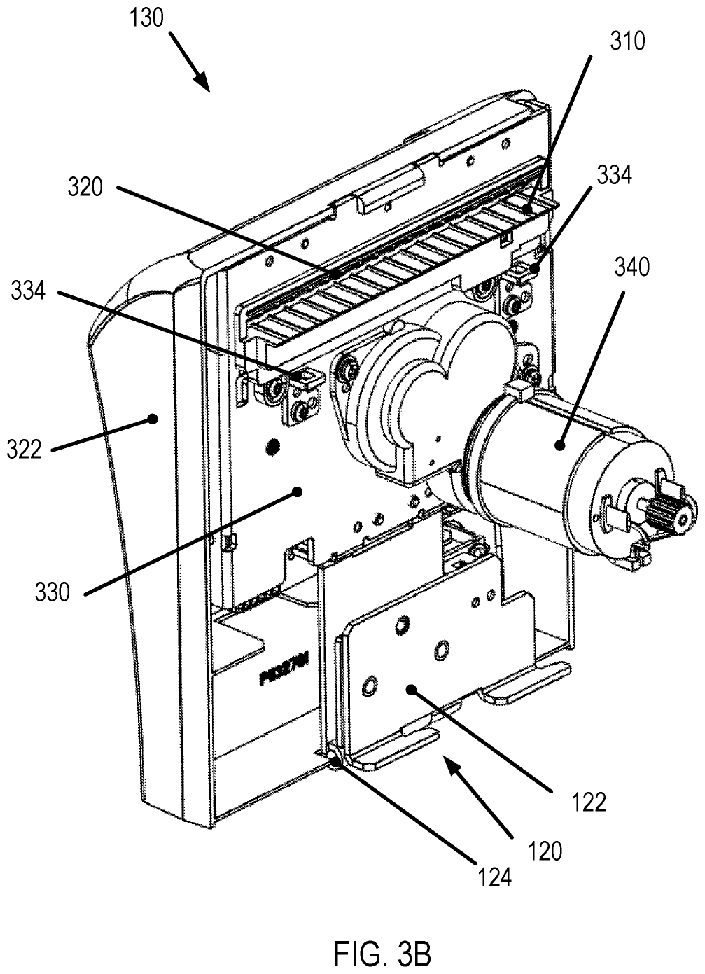

FIGS. 2A-2B illustrate views of some components of region A of the device 100, including the cutting assembly 130 (see FIGS. 3A-3B), a hinge 120, the platen assembly 140 (See FIG. 4) and the printhead assembly 150. The cutting assembly 130 is mated to the frame 104 (a portion of which is indicated) of the device 100 by the hinge 120 and secured at a secondary point by a latch (See FIG. 4). The cutting assembly 130 includes an actuatable cutting blade 320 (e.g. cutting blade, blade) and a media scraper 310 (e.g. media scraper, scraping mechanism) (Sec FIGS. 3A-3B) operably disposed proximate to a first end of the cutting assembly 130, proximate (e.g. adjacent) to the printhead 152 of the printhead assembly 150 and the platen roller 142 of the platen assembly 140, and opposite the second end of the cutting assembly at the hinge 120.

The printhead assembly 150 may transition between a disengaged position in which the printhead 152 is positioned away from the platen roller 142 of the platen assembly 140 such that the printhead 152 is not positioned to print on media, and an engaged position, in which the printhead 152 is adjacent to and forms a nip with the platen roller 142 of the platen assembly 140 and the printhead 152 is positioned to print on media (e.g. continuous linerless media web with adhesive backing). After the printhead 152 prints on the media (e.g., via the ribbon or direct thermal), the media may be cut by the actuatable cutting blade 320 of the cutting assembly 130 and dispensed from the device 100 via a media outlet 324 (see FIG. 3A).

In some examples, the printhead assembly 150 and the platen assembly 140 may jointly be considered a printing assembly.

The cutting assembly 130 may move between an engaged position (FIG. 2A) and a disengaged position (FIG. 2B) via the hinge 120. As shown in FIG. 2A, the engaged position orients the first end of the cutting assembly 130 proximately to the platen assembly 140 and the printhead assembly 150 such that the actuatable cutting blade 320 and media scraper 310 of the cutting assembly are disposed proximate (e.g., adjacent) to the printhead 152 and platen roller 142. In the engaged position, the device 100 may engage in routine printing operations, wherein the printhead assembly 150 may print the media, and subsequently expel the media via the platen assembly 140 to the cutting assembly 130 where the media may be cut and ejected from the device 100. In some embodiments, when the cutting assembly 130 rotates between the engaged and disengaged positions, the components of the cutting assembly 130 (e.g., actuatable cutting blade 320, media scraper 310, face plate, motor, mounting plate, and/or circuit board and/or electronics) can rotate in unison.

As shown in FIG. 2B, the disengaged position orients the first end of the cutting assembly 130 away from the platen assembly 140 and printhead assembly 150, relative to the positons of the same components in the engaged position. Due to the tolerance between the media scraper 310 of the cutting assembly 130 and the platen roller 142 of the platen assembly 140, which may be less than 0.25 inches (in) in the engaged position, access to the platen assembly 140 is considerably restricted when the cutting assembly is in the engaged position. When in the disengaged position, the distance between the media scraper and the platen roller 142 of the platen assembly 140 may be greater than 1 in. The increased distance between the cutting assembly 130 and the platen assembly 140 may facilitate a user accessing the platen roller 142 of the platen assembly 140 to remove a blockage or jam (e.g. due to the media adhering to and/or wrapping around the platen roller 142).

In some examples, when transitioning the cutting assembly 130 from the engaged position to the disengaged position, the distance between the media scraper and the platen assembly 140 increases in a direction that is substantially collinear, or directionally similar, to the direction of the media process path between the same components. Stated differently, the space between the media scraper 310 and the platen roller 142 which increases when the cutting assembly 130 is transitioned from the engaged position to the disengaged position, increases in a similar direction that the printed media is ejected from the printhead assembly 150 via the platen assembly 140 to the cutting assembly 130.

FIGS. 3A-3B illustrate views of the cutting assembly 130 of the device 100, according to embodiments of the present disclosure. The cutting assembly 130 includes a faceplate 322, defining the media outlet 324 which may be configured to expel media through a slot after it has been processed. For example, perimeter of the slot of the media outlet 324 can be surrounded entirely by the faceplate. The faceplate 322 may be configured to visually integrate with the housing of the device 100, such that various edge features of both the faceplate 322 and the housing are constructed of the same material, and edges thereof abut in a manner appearing to be substantially visually continuous. In some embodiments, the faceplate includes structures by which a tray may be attached to the faceplate 322, in order to retain portions of media cut by the cutting assembly 130 and expelled therefrom in an organized manner.

As shown in FIG. 3B, the cutting assembly 130 further includes the media scraper 310, the actuatable cutting blade 320, a motor 340 configured to actuate the actuatable blade, and a mounting apparatus 330, and the hinge 120. In some embodiments, the hinge 120 may be considered integrated into the cutting assembly 130. Alternatively, the hinge 120 may be considered as a separate component in other embodiments.

The components of the cutting assembly 130 are secured to the mounting apparatus 330, which may be considered as a frame, or system of support members or mounting plate. The media scraper 310 and actuatable cutting blade 320, are operatively disposed, (e.g. coupled to) proximate to a first end of the mounting apparatus 330, opposite the hinge 120. The hinge 120 is attached at the second end of the cutting assembly 130 to the mounting apparatus 330 by conventional joinery methods, which may include various fasteners, such as screws, bolts, pins, rivets, welds. The hinge 120 can be disposed below/under the media outlet 324 when the cutting assembly 130 is mounted or otherwise included on a media processing device. According to some embodiments, such as the illustrated embodiment, latch holes 334 are also disposed on the mounting apparatus 330 and secured thereto by fasteners. In other embodiments the latch holes 334 are an integrated feature of the mounting apparatus 330 or faceplate 322.

The actuatable cutting blade 320 may be configured to entirely separate (cut) a portion of media from the media ribbon, or to impart a line of weakness to the media ribbon, such that a portion of the media may be easily removed, the line of weakness defining an edge of the portion to be removed. The motor 340 may connect to an assembly including various conventional structures, such as gears, racks, pinions, axles, drivetrains, slots, pins, and the like, e.g., included in the cutting assembly 130, with which to transfer mechanical force from the motor 340 to the actuatable cutting blade 320.

The hinge 120 includes hinge plates 122 having attachment holes, as well as a hinge pin forming an axle 124, separate portions of which the hinge plates 122 are bent about to form a barrel. The hinge plates 122 are configured to mutually rotate about a hinge axis of rotation defined by the axle (e.g., axis of rotation extends in an axial direction relative to the axle), limited by the positions in which the two hinge plates abut one another (e.g., when the cutting assembly is in the engaged position). In one example, the axis of rotation of hinge extends orthogonally relative to a media path the media follows from the platen assembly 140 to the cutting assembly 130. The first hinge plate 122 is secured to the mounting apparatus 330 of the cutting assembly 130, and the second hinge plate 122 is secured to the frame 104 of the device 100, and thus the cutting assembly 130 is operable to rotate about the axle of the hinge, relative to the device 100. According to some embodiments, the hinge 120 can be one of a gate hinge, a spring hinge, a knife hinge, a barrel hinge, a block hinge, a combination thereof, and the like.

FIG. 4 illustrates the platen assembly 140 and a latch assembly 410, according to embodiments of the present disclosure. The platen assembly 140 includes the platen roller 142, platen bearings 146, and a platen axle 144. The depicted platen roller 142 defines a cylindrical body having an outer core disposed circumferential about and fixed relative to the platen axle 144. The outer core is adapted to drive media firmly and uniformly against the printhead assembly 150. In various embodiments, the outer core of the platen roller 142 may be made from a rubber or other similar material that is adapted to grip and compress media against a printhead 152 during printing operations. The depicted platen axle 144 can be a unitary structure and/or can extend the full length of the platen assembly 140, through the platen roller 142 and the platen bearings 146. The depicted platen bearings 146 are structured to allow the platen axle 144 (and platen roller 142) to rotate about a platen axis of rotation, which extends axially relative to the platen axle 144, while securely fastened in situ to the frame 104.

FIG. 4 further illustrates the latch assembly 410, including latching pegs 412, a latch axle 418, a lever 414 and a spring 416. The latch pegs 412 are secured to the latch axle 418, which is tensioned by the spring 416, and the lever 414 is secured to the latch axle 418. The latch pegs 412 are configured to interface with latch holes disposed on the cutting assembly, which may be disposed in the mounting apparatus 330 or within a portion of the faceplate 322. The latch assembly 410 is used to secure the cutting assembly 130 to the device 100 at a second point of contact (the first being the hinge 120). The latch assembly 410 may be disengaged by depressing the lever 414, which provides enough force to overcome the retaining force applied to the latch axle 418 by the spring 416. The latch axle 418 rotates (about a latch axis of rotation that extends axially related to the latch axle 418), and the latch pegs 412 no longer engage with the latch holes 334 of the cutting assembly 130, and the cutting assembly 130 is free to rotate about the axis of rotation of the hinge 120. The latch axle 418 can extend be parallel to the platen axle 144 and the axes of rotation of the latch axle 418 and the platen axle 144 are parallel to each other (e.g., within tolerances). The latch assembly may be reengaged by returning the cutting assembly 130 to the engaged position, the process of which biases the latch pegs 412 along an inclined surface thereof, forcing a rotation of the latching assembly, facilitating the latch pegs 412 to re-engage with the latch holes 334 of the cutting assembly 130.

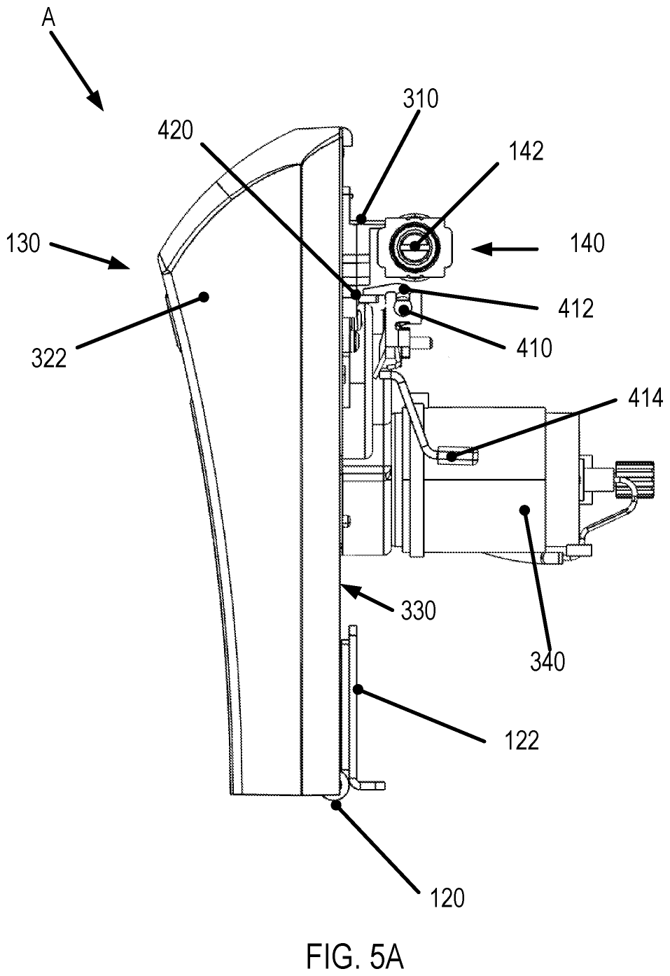

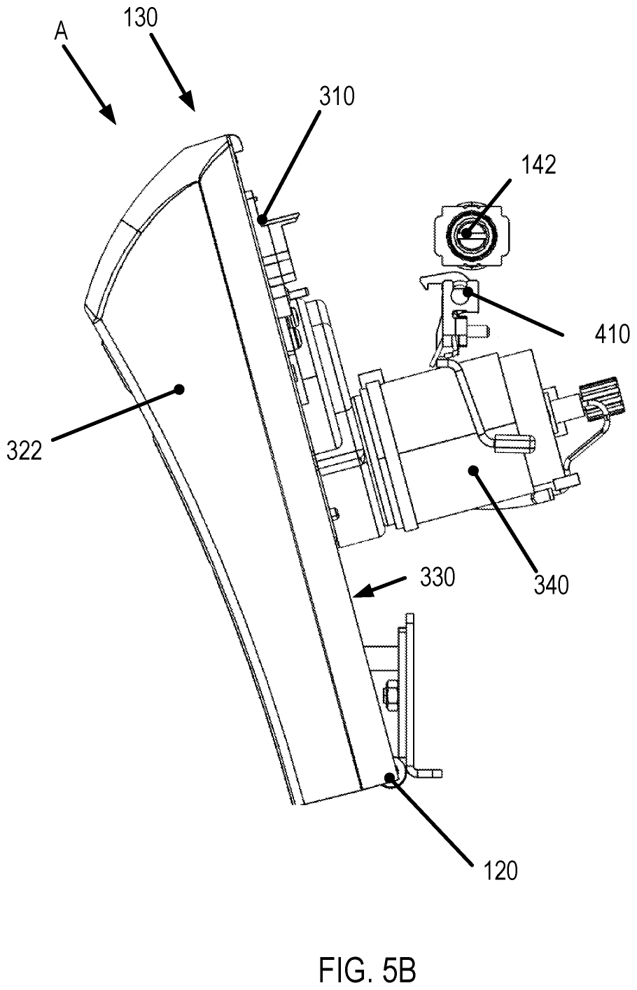

FIG. 5A. illustrates the interaction between the cutting assembly 130 and the platen assembly 140 in the engaged position, with some components of the device 100 hidden, such that certain features are more easily viewed, according to embodiments of the present disclosure.

According to some embodiments, the axis of rotation of the platen roller 142 and the axis of rotation of the hinge 120 are parallel (e.g., within tolerances). Stated differently, when the cutting assembly 130 transitions from the engaged position to the disengaged position, the axis of rotation of the hinge 120 about which the cutting assembly 130 rotates is parallel to the axis of rotation about which the platen roller 142 rotates. Both the axis of rotation of the platen roller 142 and the axis of rotation of the hinge 120 are substantially orthogonal to the direction in which media is expelled from the platen assembly 140. In other embodiments, the axis of rotation of the platen roller 142 and the axis of rotation of the hinge 120 are skewed and non-orthogonal.

According to some embodiments, the axis of rotation of the latch axle 418 and the axis of rotation of the hinge 120 are parallel. Stated differently, when the cutting assembly 130 transitions from the engaged position to the disengaged position, the axis of rotation of the hinge 120 about which the cutting assembly 130 rotates is parallel to the axis of rotation about which the latch axle 418 rotates (e.g., within tolerances). Both the axis of rotation of the latch axle 418 and the axis of rotation of the hinge 120 are substantially orthogonal to the direction in which media is expelled from the platen assembly 140. In other embodiments, the axis of rotation of the platen roller 142 and the axis of rotation of the hinge 120 are skewed and non-orthogonal.

FIG. 5B. illustrates the interaction between the cutting assembly 130 and the platen assembly 140 in the disengaged position, with some components of the device 100 hidden, such that certain features are more easily viewed, according to embodiments of the present disclosure.

In some examples, the range of rotation of the cutting assembly 130 about the hinge 120 relative to the device 100 is biased (e.g. limited) by internal components, such as the motor 340, which may rotate into contact with other internal components such as the frame 104, or platen assembly 140. In other examples, the range of rotation of the cutting assembly 130 about the hinge 120 relative to the device 100 is biased (e.g. limited) by biasing elements, such as pinned or sliding linkages, springs, and other components capable of limiting the rotation of the cutting assembly 130 about the hinge 120, which may join the frame of the device 100 and the cutting assembly 130 at secondary or tertiary locations.

In some examples, the range of rotation of the cutting assembly 130 about the hinge 120 relative to the device 100, is in a range of 0 degrees (e.g. engaged position) to 45 degrees. According to various embodiments, the upper bound of the range of rotation of the cutting assembly 130 about the hinge 120, relative to the engaged position being at 0 degrees, is about 15 degrees, about 20 degrees, about 25 degrees, about 30 degrees, about 35 degrees, about 40 degrees, about 45 degrees, about 50 degrees, about 55 degrees or about 60 degrees.

In some examples, the disengaged position may refer to any position of the cutting assembly 130 that s not the engaged position. Stated differently, the cutting assembly at any rotational index greater than 0 degrees (the engaged position being 0 degrees), may be considered to be in the disengaged position, regardless of the upper bound of the range of rotation of the cutting assembly 130.

Some embodiments include sensors configured to detect if the cutting assembly is in the engaged position and/or if the faceplate 322 is attached to the cutting assembly 130 (e.g., from the mounting apparatus 330). Sensors may take various forms, and may be disposed in the device 100, or in the cutting assembly 130, or in a combination of both. Sensors may be magnetic sensors, optical sensors, or other types of proximity, interrupt, transmissive, or reflective sensors. The sensors may work in conjunction with a control circuit, or processor, such that when the sensors detects that the cutting assembly 130 is in the disengaged position or the faceplate 322 is detached from the cutting assembly 130 (e.g., from the mounting apparatus 330), the processor does not provide power to and/or does not drive the motor 340 responsible for actuating the actuatable cutting blade 320, such that the cutting function of the cutting assembly is inoperable. When the sensors detects that the cutting assembly 130 is in the engaged position and that the faceplate 322 is attached to the cutting assembly 130, the processor may provide power to and/or drive the motor 340, provided other operational parameters are met.

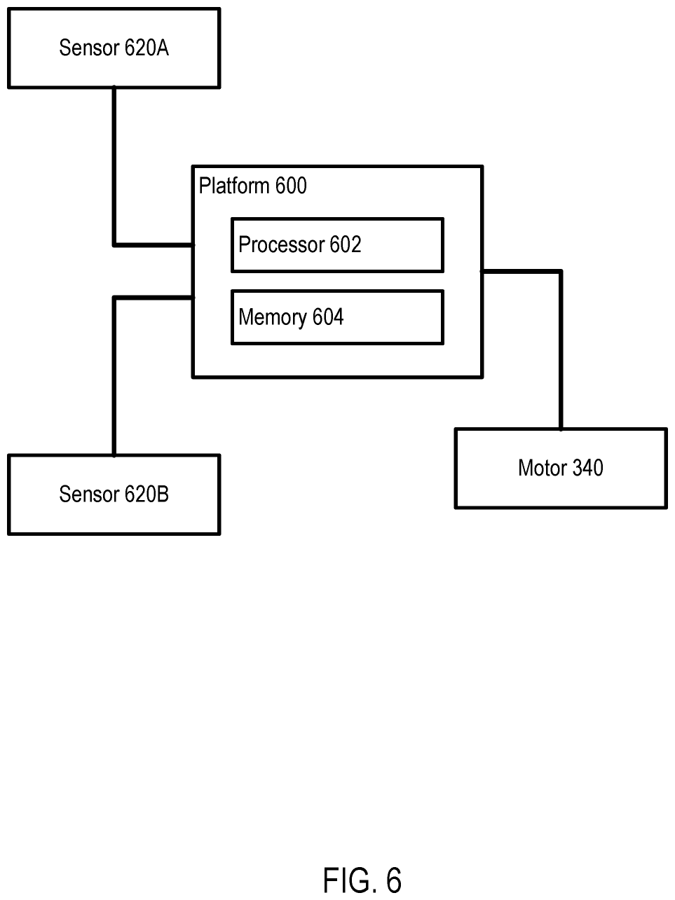

FIG. 6 is a block diagram representative of an example logic circuit capable of implementing, for example, one or more components of the device 100 of FIGS. 1-5B. The circuit can be included in the cutting assembly, the device 100, or a combination of both. The example logic circuit of FIG. 6 is a processing platform 600 capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs).

The example processing platform 600 of FIG. 6 includes a processor 602 such as, for example, one or more microprocessors, controllers, and/or any suitable type of processor. The example processing platform 600 of FIG. 6 includes a memory 604 (e.g., volatile memory, non-volatile memory) accessible by the processor 602 (e.g., via a memory controller). The example processor 602 interacts with the memory 604 to obtain, for example, machine-readable instructions stored in the memory 604 corresponding to, for example, the operations represented by the flowcharts of this disclosure. Additionally, or alternatively, machine-readable instructions corresponding to the example operations described herein may be stored on one or more removable media (e.g., a compact disc, a digital versatile disc, removable flash memory, etc.) that may be coupled to the processing platform 600 to provide access to the machine-readable instructions stored thereon.

The processing platform 600 receives inputs from sensors 620A-620B (generally or collectively, sensor(s) 620). Sensors 620 are illustrated in FIG. 6 as in duplicate, but the platform 600 may connect to as many as fifty sensors 620. The sensors 620 may be configured to detect whether the cutting assembly 130 of device 100 is in the engaged position or the disengaged position. The sensors 620 may be configured to detect whether the faceplate 322 of the cutting assembly has been removed. The sensors 620 may be configured to detect whether the printhead assembly 150 is in the engaged position or the disengaged position. The processing platform receives the sensor output, and based on the value of the output, may execute a command to cease driving and/or delivery of power to the motor 340 (e.g. disable the cutting assembly), or to actuate or drive the motor 340, thus actuating the actuatable cutting blade 320 (e.g. enable the cutting assembly). If the sensor detects that the cutting assembly is in the disengaged position, the platform 600 may disable and/or cease driving the motor 340. If the printhead 152 is in the disengaged position, the platform 600 may disable and/or cease driving the motor 340. If the faceplate 322 has been removed from the cutting assembly, the platform 600 may disable and/or cease driving the motor 640.

According to some embodiments, The platform 600 may be used in conjunction with other printer control circuitry and programming, and other conditions may be necessitated to fully enable the device 100 to process media.

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAS, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

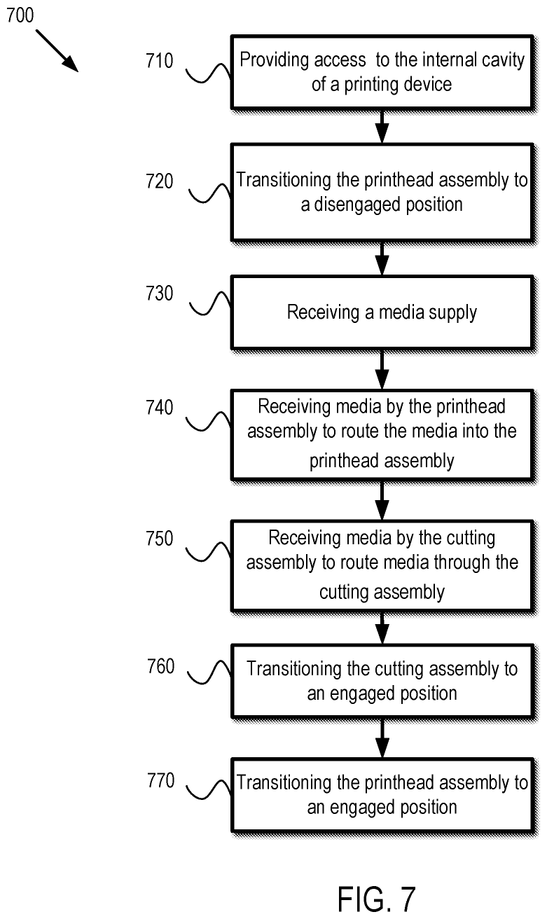

FIG. 7 illustrates a flowchart 700 for method of loading media into a printer, such as the device 100, according to embodiments of the present disclosure.

At block 710 of the method, access to the internal cavity of a printing device, such as device 100, is provided to a user. In various examples, this may be achieved via an access door disposed in a housing about the printing device, or by moving the housing, or a portion thereof.

At block 720 of the method, the cutting assembly (e.g. cutting assembly 130 of device 100) transitions from the engaged position to the disengaged position, which in various embodiments, may be achieved in response to receiving an actuation of a lever which disengages a latch (e.g. latch assembly 410), facilitating the release of the cutting assembly from a secondary point of contact, such that the cutting device rotates about a hinge joining the cutting assembly and the printing device at a primary point of contact. When the latching mechanism is disengaged, the cutting assembly is operable to rotate about the hinge, thus increasing the distance between the scraper (e.g. media scraper) and the platen roller (e.g. platen roller 142). The printhead assembly (e.g. printhead assembly 150) may also transition to a disengaged position, in which the printhead (e.g. printhead 152) of the printhead assembly is spaced away from the platen roller.

At block 730 of the method, a media supply is received in the printing device. The media supply may be in the form of a roll, spool or a fan-fold stack. Such media may include a continuous web such as a spool of linerless media. In some examples, the media supply may be disposed on a media hanger or spindle (e.g. media hanger or spindle 108).

At block 740 of the method, a portion of the media is routed between the printhead assembly and platen roller assembly, which may be achieved by receiving the portion of the media web under the printhead and above the platen roller in a direction substantially perpendicular to the direction of the process path of the device and/or in an axial direction relative to the platen axle. In some examples, block 740 may require other maneuvers to properly insert the media into the process path, such as winding the media about rollers or other components in the printing device. For example, in some examples, the platen assembly includes auxiliary structures such as a frame and media guides, which require the media to be fed through the platen assembly in the same direction as the media process path.

At block 750 of the method, a terminal end of the media web is routed through the media outlet of the cutting assembly while the cutting assembly is in the disengaged position to provide space for navigating the terminal end of the media through the slot of the media outlet. For example, in one example embodiment, media cannot be inserted into the cutting assembly or media outlet laterally from a side of the printer. Thus, by allowing the cutting assembly 130 to rotate to the disengaged position provides addition space to thread the terminal end of the media through the cutting assembly and the media outlet in a direction that generally corresponds to a media path the media travels from the platen roller to the media outlet.

At block 760 of the method, the cutting assembly is transitioned from the disengage position to the engaged position, e.g., in response to rotation of the cutting assembly about the hinge towards the device 100, until the latch is reengaged, and the cutting assembly is secured at the primary and secondary points of contact. In the engaged position, the media scraper and/or cutting blade is immediately proximate (e.g. adjacent) to the platen roller.

At block 770 of the method, the printhead assembly is transitioned to the engaged position. In the engaged position, the printhead is generally configured to form a nip with the platen roller to pinch the media between the printhead and the platen roller. After block 770, the media is loaded in the printer, the printer is ready for operation, and the method may be completed.

With regard to FIG. 7, the method illustrated by flowchart 700 may be performed, in some cases, in an order other than in the order presented, and may omit certain steps, or include other steps not described.

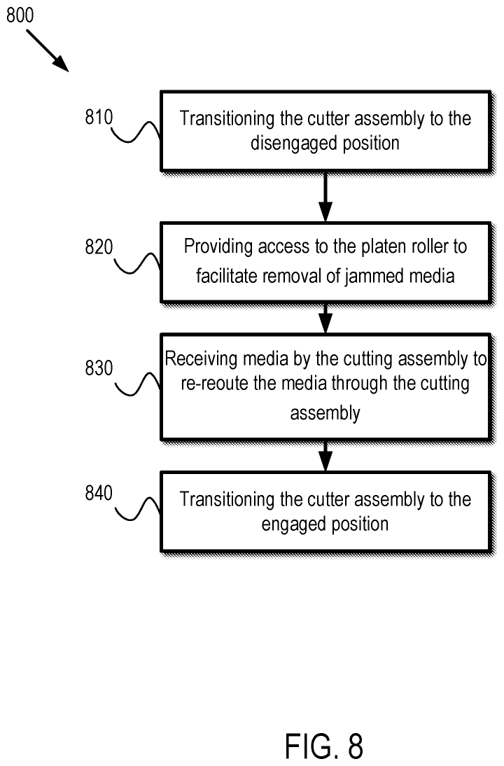

FIG. 8 illustrates a flowchart 800 for a method of removing a media jam from a printing device (e.g. device 100), according to embodiments of the present disclosure.

At block 810 of the method, the cutting assembly (e.g. cutting assembly 130 of device 100) is transitioned from the engaged position to the disengaged position, which in various embodiments, may be achieved in response to actuation of a lever which disengages a latch (e.g. latch assembly 410), facilitating the release of the cutting assembly from a secondary point of contact, such that the cutting device rotates about a hinge joining the cutting assembly and the printing device at a primary point of contact. When the latching mechanism is disengaged, the cutting assembly is operable to rotate about the hinge, thus increasing the distance between the scraper (e.g. media scraper) and the platen roller (e.g. platen roller 142). When the cutting assembly is in the disengaged position, there is space to access the platen roller from a front of the printing device and/or from a side of the printing device.

At block 820, with the cutting assembly in the disengaged position, access to the platen roller is provided to facilitate removal of the jammed media from the platen roller without removing the platen roller from the platen assembly and the printing device. Removal of the jammed media may be facilitated by manual articulation of the platen roller, in the event that media is adhered thereto and/or pulling the media away from the platen roller. In some examples the media jammed in the printing device may be a web of linerless media, the adhesive surface of which has adhered to the platen roller.

At block 830, a terminal end of media web may be received and/or re-routed through the platen assembly and printhead assembly and through cutting assembly and the media outlet of the cutting assembly.

At block 840 of the method the cutting assembly is transitioned from the disengaged position to the engaged position, by rotating the cutting assembly about the hinge towards the device 100, until the latch is reengaged, and the cutting assembly is secured at the primary and secondary points of contact. In the engaged position, the media scraper and/or cutting assembly is immediately proximate (e.g. adjacent) to the platen roller. In some embodiments, the terminal end of the media web can be fed through the media outlet of the cutting assembly as the cutting assembly is being transitioned from the disengage position to the engaged position. After block 830 the media jam is removed, the media is re-routed through the printing device, and the method may be completed.

With regard to FIG. 8, the method illustrated by flowchart 800 may be performed, in some cases, in an order other than in the order presented, and may omit certain steps, or include other steps not described.

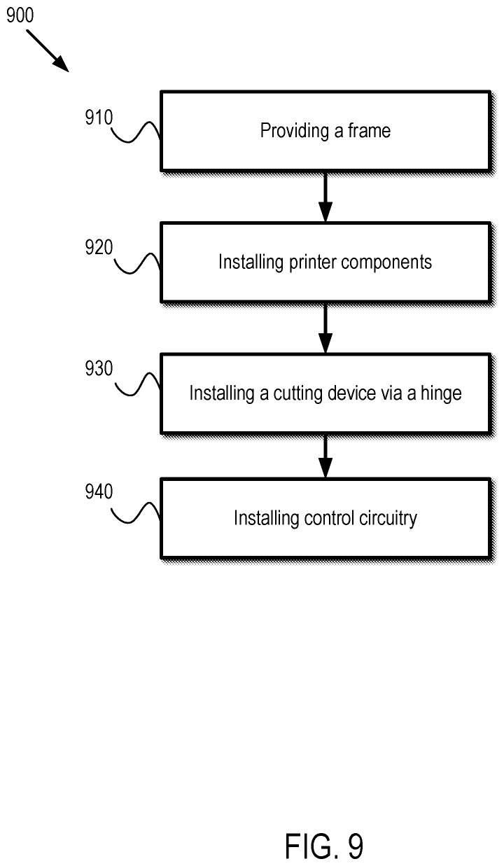

FIG. 9 illustrates a flowchart 900 of a method of forming a printer (e.g. device 100), according to embodiments of the present disclosure.

At block 910 of the method, a frame (e.g. frame 104) or chassis is provided. The frame may be configured to facilitate the attachment of various printer components to the frame, via fasteners or other attachment methods.

At block 920 of the method various printer components are installed, such as media hangers or spindles (e.g. media hanger or spindle 108), drive assemblies, a platen assembly (e.g. platen assembly 140), a printhead assembly (e.g. printhead assembly 150), the ribbon supply spindle (e.g. ribbon supply spindle 110), a ribbon take-up spindle (e.g. ribbon take-up spindle 112), a housing, and the like.

At block 930 of the method, a cutting assembly (e.g. cutting assembly 130) is mounted to the frame of the printing device. The cutting assembly includes an actuatable cutting blade (e.g. actuatable cutting blade 320) and a media scraper (e.g. media scraper 310) operably disposed proximate to a first end of the cutting assembly 130, proximate (e.g. adjacent) to the printhead (e.g. printhead 152) of the printhead assembly and the platen roller of the platen roller assembly, and opposite the second end of the cutting assembly at a hinge (e.g. hinge 120). The cutting assembly may be latched in an engaged position and may move between the engaged position and a disengaged position via the hinge and based on an operation of the latch. The engaged position orients the first end of the cutting assembly proximately to the platen roller assembly and the printhead assembly. The disengaged position orients the first end of the cutting assembly away from the platen assembly and printhead assembly, relative to the positions of the same components in the engaged position. Due to the tolerance between the media scraper of the cutting assembly 130 and the platen roller 142 of the platen assembly, which may be less than 0.25 inches (in) in the engaged position, access to the platen assembly 140 is considerably restricted. When in the disengaged position, the distance between the media scraper and the platen assembly 140 may be greater than 1 in.

In some examples, when transitioning the cutting assembly 130 from the engaged position to the disengaged position, the distance between the media scraper and the platen assembly 140 increases in a direction that is substantially collinear, or directionally similar, to the direction of the media process path between the same components. Stated differently, the space between the media scraper and the platen roller 142 which increases when the cutting assembly 130 is transitioned from the engaged position to the disengaged position, increases in a similar direction that the printed media is ejected from the printhead assembly 150 via the platen assembly 140 to the cutting assembly 130.

At block 940 of the method, control circuitry (e.g. platform 600) is connected between the cutting assembly and the printing device. After block 940, the method may be concluded.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A printing device, comprising:
a frame;
a printing assembly including a printhead and a platen roller; and
a cutting assembly including a cutting blade and a media scraper, the cutting assembly is disposed on a mounting apparatus which is mated to the frame by a hinge and has an engaged position and a disengaged position, wherein
in the engaged position, the cutting assembly is immediately proximate to the printing assembly, such that the media scraper is configured to guide a printed media off the platen roller and to the cutting blade, and
in the disengaged position, the mounting apparatus is rotated about the hinge, and a distance between the cutting assembly and the printing assembly is increased, thus increasing a space defined between the platen roller and the media scraper.

2. The printing device of claim 1, wherein the distance between the cutting assembly and the printing assembly is increased in a direction that is substantially collinear with a direction of a process path of the printed media defined between the printing assembly and the cutting assembly.

3. The printing device of claim 1, wherein the cutting blade and media scraper of the cutting assembly are operatively coupled to an end of the mounting apparatus opposite the hinge.

4. The printing device of claim 1, wherein an axis of rotation of the platen roller and an axis of rotation of the hinge are parallel.

5. The printing device of claim 1, wherein an axis of rotation of the platen roller and an axis of rotation of the hinge are skewed and non-orthogonal.

6. The printing device of claim 1, further comprising a latch, configured to secure the mounting apparatus when in the engaged position.

7. The printing device of claim 6, wherein the latch is further configured to release the mounting apparatus to transition to the disengaged position.

8. (canceled)

9. The printing device of claim 1, wherein the mounting apparatus comprises a sensor, such that the printing device is restricted from actuating the cutting blade when the cutting assembly is in the disengaged position.

10. (canceled)

11. (canceled)

12. The printing device of claim 1, wherein an upper bound of a range of rotation of the mounting apparatus about the hinge is between 10 degrees and 45 degrees.

13. The printing device of claim 1, wherein an upper bound of a range of rotation of the mounting apparatus about the hinge is between 10 degrees and 25 degrees.

14. (canceled)

15. A cutting device, comprising:
a hinge;
an actuatable cutting blade;
a media scraper disposed adjacent to the actuatable cutting blade;
a first mounting apparatus disposed on a first side of the hinge, the actuatable cutting blade and the media scraper are disposed on the first mounting apparatus; and
a second mounting apparatus disposed on a second side of the hinge, the second mounting apparatus configured to be coupled to a printer, the first mounting apparatus and the second mounting apparatus rotate relative to each other about the hinge between an engaged position in which the actuatable cutting blade is configured to be operable and a disengaged position in which the actuatable cutting blade is configured to be inoperable.

16. The cutting device of claim 15, wherein the hinge is configured to facilitate abutting the cutting device to a printing device and separating the cutting device from the printing device, the hinge defining an engaged position and a disengaged position of the cutting device relative to the printing device, such that in the engaged position, the media scraper is immediately proximate to a platen roller of the printing device, and the media scraper is configured to guide printed media from the platen roller to the actuatable cutting blade, and in the disengaged position, the first mounting apparatus is rotated about the hinge, such that a distance between the media scraper and the platen roller is increased in a direction substantially collinear with a direction of a portion of a media process path.

17. The cutting device of claim 16, further configured to interface with a latching mechanism of the printing device, such that the cutting device is secured and is restricted from rotating about the hinge when in the engaged position.

18. The cutting device of claim 16, further comprising a sensor and control circuitry, configured such that the cutting device is restricted from actuating the actuatable cutting blade when in the disengaged position.

19. The cutting device of claim 16, wherein rotation of the cutting device about the hinge is biased by one or more springs joining the cutting device and the printing device.

20. The cutting device of claim 16, wherein rotation of the cutting device about the hinge is biased by one or more linked members joining the cutting device and the printing device.

21. The cutting device of claim 16, wherein an upper bound of a range of rotation of the cutting device about the hinge is between 10 degrees and 45 degrees.

22. The cutting device of claim 16, wherein an upper bound of a range of rotation of the cutting device about the hinge is between 10 degrees and 25 degrees.

23-26. (canceled)

27. A printing device, comprising:
a cutting assembly driven by a motor, the cutting assembly configured to be moved between an engaged position and a disengaged position;
a sensor configured to detect whether the cutting assembly is in the engaged position or the disengaged position; and
a processor configured to:
disable the cutting assembly in response to an output of the sensor indicating the cutting assembly is in the disengaged position; and
enable the cutting assembly in response to the output of the sensor indicating the cutting assembly is in the engaged position.

28. The printing device of claim 27, further comprising a second sensor configured to detect whether a faceplate of the cutting assembly is coupled to the cutting assembly, wherein the processor is configured to disable the cutting assembly in response to an output of the second sensor indicating the faceplate has been removed from the cutting assembly and enable the cutting assembly in response to the output of the sensor indicating the cutting assembly is in the engaged position.
